(19) United States
(12) Patent Application Publication
(10) Pub. No.: US 2026/0202642 A1
(43) Pub. Date: Jul. 16, 2026

(54) COMPOSITION, OPTICAL LENS USING THE SAME, AND LENS ASSEMBLY

(71) Applicant: SAMSUNG ELECTRO-MECHANICS CO., LTD., Suwon-si (KR)

(72) Inventors: Seong Chan PARK, Suwon-si (KR); Su Min KANG, Suwon-si (KR); Sang Hyun KWON, Suwon-si (KR)

(73) Assignee: SAMSUNG ELECTRO-MECHANICS CO., LTD., Suwon-si (KR)

(21) Appl. No.: 19/385,743

(22) Filed: Nov. 11, 2025

(30) Foreign Application Priority Data
Jan. 10, 2025 (KR) 10-2025-0004030

(51) Int. Cl. G02B 9/10; G02B 1/04; G02B 1/10

(52) U.S. Cl. CPC G02B 9/10; G02B 1/04; G02B 1/10

(57) ABSTRACT

A composition according to an embodiment of the present disclosure may include a compound represented by [Chemical Formula 1]:

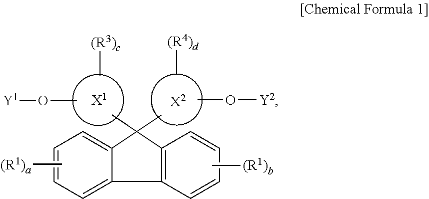

X1 and X2 are each an aromatic ring, R1, R2, R3 and R4 are each a substituent, a, b, c and d are each an integer from 0 to 4, and any one of Y1 and Y2 may include a substituted or unsubstituted epoxy group, and the other may include a substituted or unsubstituted (meth)acrylate group.

### CROSS-REFERENCE TO RELATED APPLICATIONS

This application claims the benefit under 35 USC 119 (a) of Korean Patent Application No. 10-2025-0004030 filed on Jan. 10, 2025, in the Korean Intellectual Property Office, the entire disclosure of which is incorporated herein by reference for all purposes.

### BACKGROUND

### 1. Field

The present disclosure relates to a composition, an optical lens using the same, and a lens assembly, and for example, to an adhesive composition for a lens, an optical lens for a camera module, and a lens assembly.

### 2. Description of the Background

With increase in convenience devices of vehicles and a growth of autonomous driving technology, development of vehicle optical lenses to recognize driving environments and obstacles and to collect information about a vehicle's surroundings has become increasingly important. In general, glass lenses used as vehicle optical lenses, have excellent optical characteristics such as transmittance and refractive index, but have disadvantages of being heavy and having poor impact resistance. Therefore, when a plastic lens that may maintain performance even in a high-temperature environment is developed and applied to a vehicle optical lens, the lens may be lightened and impact resistance thereof may be improved.

However, in order to use a composite lens in which two or more plastic lenses are bonded with an adhesive in a high-temperature environment, research is required to develop an adhesive material that may maintain adhesion between the plastic lenses while satisfying optical characteristics. In particular, composite lenses composed of plastic lenses may be deformed in high-temperature environments, which may cause optical axis misalignment between the lenses and result in a decrease in resolution.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a composition includes a compound represented by [Chemical Formula 1],

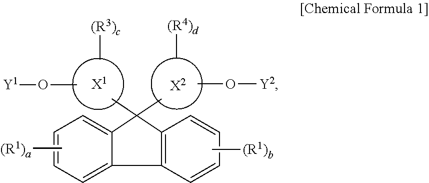

wherein X1 and X2 are each an aromatic ring, R1, R2, R3 and R4 are each a substituent, a, b, c and d are each an integer from 0 to 4, and where one of Y1 and Y2 includes a substituted or unsubstituted epoxy group, and the other includes a substituted or unsubstituted (meth)acrylate group.

The X1 and X2 of [Chemical Formula 1] may each be a benzene ring.

The R1, R2, R3 and R4 of [Chemical Formula 1] may each be independently a halogen group, a cyano group, a nitro group, a hydroxy group, a substituted or unsubstituted C1 to C10 alkyl group, a substituted or unsubstituted C1 to C10 alkoxy group, a substituted or unsubstituted C2 to C10 alkene group, a substituted or unsubstituted C2 to C10 alkyne group, or a substituted or unsubstituted phenyl group.

The a, b, c and d of [Chemical Formula 1] may each be integers of 0.

The a and b of [Chemical Formula 1] may each be integers of 1, and the c and d of [Chemical Formula 1] may each be integers of 0.

The compound represented by the [Chemical Formula 1] may include a compound represented by the following [Chemical Formula 2] or [Chemical Formula 3]:

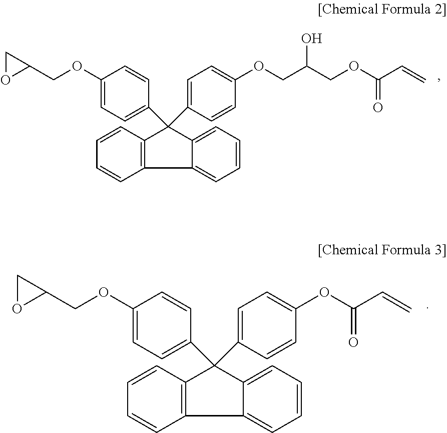 [SMILES: C=CC(=O)OCC(O)COc1ccc(C2(c3ccc(OCC4CO4)cc3)c3ccccc3-c3ccccc32)cc1 ; C=CC(=O)Oc1ccc(C2(c3ccc(OCC4CO4)cc3)c3ccccc3-c3ccccc32)cc1]

In another general aspect, an optical lens includes first and second lenses, and an adhesive layer interposed between the first and second lenses, wherein the adhesive layer includes a repeating unit derived from a compound represented by the following [Chemical Formula 1],

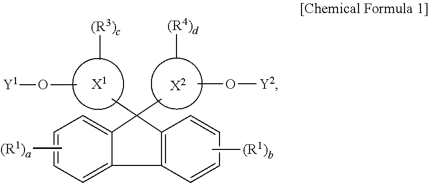

wherein X1 and X2 are each an aromatic ring, R1, R2, R3 and R4 are each a substituent, a, b, c and d are each an integer from 0 to 4, where one of Y1 and Y2 includes a substituted or unsubstituted epoxy group, and the other includes a substituted or unsubstituted (meth)acrylate group.

A refractive index of the first lens may be greater than a refractive index of the adhesive layer, and the refractive index of the adhesive layer may be greater than a refractive index of the second lens.

The refractive index of the first lens may be 1.55 or more and 1.71 or less, the refractive index of the adhesive layer may be 1.47 or more and 1.67 or less, and the refractive index of the second lens may be 1.43 or more and 1.63 or less.

A lens assembly may include the optical lens.

Other features and aspects will be apparent from the following detailed description, the drawings, and the claims.

### BRIEF DESCRIPTION OF DRAWINGS

FIG. 1 is a cross-sectional view schematically illustrating an optical lens according to an embodiment of the present disclosure.

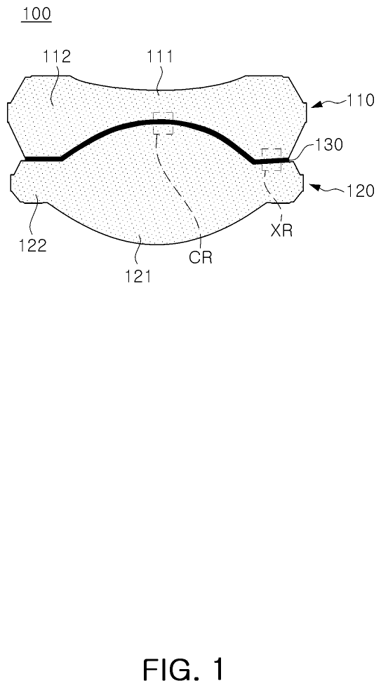

FIG. 2A is an image illustrating the flare phenomenon of Example 2 and FIG. 2B is an image illustrating the flare phenomenon of Comparative Example 2.

FIG. 3A illustrates an image of filming an appearance of Example 3-1 after completing a thermal shock test for Example 3-1, FIG. 3B illustrates an image of filming an appearance of Example 3-2 after completing a thermal shock test for Example 3-2, and FIG. 3C illustrates an image of an appearance of filming Comparative Example 3 after completing a thermal shock test for Comparative Example 3.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Unless otherwise specified in the present disclosure, “substitution” means that at least one hydrogen atom in a compound is substituted with a halogen atom (F, Cl, Br, I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, or a combination thereof. Additionally, each of the above-mentioned exemplified substituents may be substituted or unsubstituted.

An aspect of the present disclosure may be to provide a composition having excellent optical characteristics and high-temperature reliability, an optical lens using the same and a lens assembly, for example, an adhesive composition for a lens and an optical lens and a lens assembly for a camera module.

However, problems to be solved by the present disclosure may not be limited to the above, and may be more easily understood in the process of describing specific embodiments of the present disclosure.

### Composition

As described above, as usage environments of optical lenses have become increasingly harsh, demand for optical lenses having excellent optical characteristics and high-temperature reliability has been increasing. However, in order to use an optical lens in a form of a composite lens in which two or more lenses are bonded together in a high-temperature environment, an adhesive composition that may satisfy optical characteristics while maintaining adhesive strength between the lenses may be required.

Although various compounds satisfying the physical characteristics as adhesives may be used as adhesive compositions, fluorene compounds may have excellent thermal stability and optical characteristics such as refractive index, or the like, it may be advantageous to be used as compositions for optical lens adhesive. However, additional design of a chemical structure of the fluorene compound may be required to improve the optical characteristics and high-temperature reliability of the optical lens.

From this perspective, a composition according to an embodiment may include a compound represented by [Chemical Formula 1].

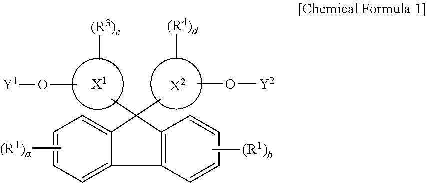

In this case, X1 and X2 may each be an aromatic ring. The aromatic ring may be a monocyclic ring or a condensed ring. The aromatic rings may be, for example, a benzene ring, a naphthalene ring, an anthracene ring, a phenanthrene ring, a perylene ring, a tetracene ring, a pyrene ring, a benzpyrene ring, a chrysene ring, a triphenylene ring, an acenaphthene ring, or the like. The aromatic ring may be a benzene ring, but the present disclosure is not limited thereto.

R1, R2, R3 and R4 may each be a substituent. R1, R2, R3 and R4 may each independently be a halogen group, a cyano group, a nitro group, a hydroxy group, a substituted or unsubstituted C1 to C10 alkyl group, a substituted or unsubstituted C1 to C10 alkoxy group, a substituted or unsubstituted C2 to C10 alkene group, a substituted or unsubstituted C2 to C10 alkyne group, or a substituted or unsubstituted phenyl group. The halogen group may be, for example, fluorine, chlorine, bromine, and/or iodine. The alkyl, alkene, alkyne groups, or the like may each be a form of straight-chain or branched-chain.

For example, the alkyl group of C1 to C10 may be a methyl group, an ethyl group, an n-propyl group, an isopropyl group, an n-butyl group, an s-butyl group, a t-butyl group, an i-butyl group, an n-pentyl group, an i-pentyl group, a neopentyl group, a t-pentyl group, a cyclopentyl group, a 1-methylpentyl group, a 3-methylpentyl group, a 2-ethylpentyl group, a 4-methyl-2-pentyl group, a n-hexyl group, a 1-methylhexyl group, a 2-ethylhexyl group, a 2-butylhexyl group, a cyclohexyl group, a 4-methylcyclohexyl group, a 4-t-butylcyclohexyl group, a n-heptyl group, a 1-methylheptyl group, a 2,2-dimethylheptyl group, a 2-ethylheptyl group, a 2-butylheptyl group, a n-octyl group, a t-octyl group, 2-ethyloctyl group, a 2-butyloctyl group, a 2-hexyloctyl group, a 3,7-dimethyloctyl group, a cyclooctyl group, an n-nonyl group, an n-decyl group, or the like, but the present disclosure is not limited thereto.

For example, the C1 to C10 alkoxy group may be a methoxy group, an ethoxy group, an n-propoxy group, an isopropoxy group, an n-butoxy group, an s-butoxy group, a t-butoxy group, an i-butoxy group, an n-pentoxy group, an i-pentoxy group, a neopentoxy group, a t-pentoxy group, an n-hexoxy group, a 2-methylhexoxy group, a 2-ethylhexoxy group, an n-heptoxy group, a 2-ethylheptoxy group, an n-octoxy group, a 2-ethyloctoxy group, an n-nonoxy group, an n-decoxy group, or the like, but the present disclosure is not limited thereto.

For example, the C2 to C10 alkene group may be an ethene group, a propene group, an allyl group, a 1-butene group, a 2-butene group, an isobutene group, a 1-pentene group, a 2-pentene group, a 3-methyl-1-butene group, a 1-hexene group, a 2-hexene group, a 3-methyl-1-pentene group, a 1-heptene group, a 2-heptene group, a 3-methyl-1-hexene group, a 1-octene group, a 2-octene group, a 4-methyl-1-pentene group, a 1-nonene group, a 2-nonene group, a 5-methyl-1-heptene group, a 1-decene group, a 2-decene group, a 4-ethyl-1-pentene group, or the like, but the present disclosure is not limited thereto. For example, the C2 to C10 alkyne group may be an ethynyl group, a propane group, a butane group, an isobutane group, a pentanyl group, a hexane group, a heptanyl group, an octane group, a nonane group, a decaine group, or the like, but the present disclosure is not limited thereto.

For example, the phenyl group may be a phenyl group, a methylphenyl group, an ethylphenyl group, a chlorophenyl group, a bromophenyl group, a nitrophenyl group, a hydroxyphenyl group, an isopropylphenyl group, a trifluoromethylphenyl group, a phenolphenyl group, a benzoylphenyl group, or the like, but the present disclosure is not limited thereto.

The a, b, c and d may each be an integer from 0 to 4. For example, a, b, c, and d may each be 0. In this case, a fluorene skeleton and an aromatic ring may not have substituents. For example, a and b may each be 1, and c and d may each be 0. The type and number of the substituents may vary depending on a characteristics of an aimed composition, and from a perspective of curability, a, b, c, and d may be each 0, but the present disclosure is not limited thereto.

One of Y1 and Y2 may include a substituted or unsubstituted epoxy group, and the other may include a substituted or unsubstituted (meth)acrylate group.

For example, Y1 may include the substituted or unsubstituted epoxy group, and Y2 may include the substituted or unsubstituted (meth)acrylate group. For example, one of Y1 and Y2 may include the epoxy group at the end, and the other may include the (meth)acrylate group at the end. For example, one of Y1 and Y2 may be the epoxy group, and the other may be the (meth)acrylate group.

A chemical structure of the fluorene compound represented by [Chemical Formula 1] included in the composition may require a balanced design considering optical characteristics, high-temperature reliability, flexibility, and durability.

When both Y1 and Y2 contain a (meth)acrylate group, the refractive index and adhesive strength of a cured product may be reduced, and a large amount of outgassing may be generated from the fluorene compound during curing, which may cause peeling of a lens in a high temperature and/or high humidity environment. When both of Y1 and Y2 contain an epoxy group, the adhesive strength may be improved, but there is a concern that a hardness after curing may increase excessively and an impact resistance may deteriorate.

On the other hand, according to an embodiment of the present disclosure, one of Y1 and Y2 includes an epoxy group and the other includes a (meth)acrylate group, thereby securing balanced physical properties for optical characteristics, high-temperature reliability, flexibility, and durability.

As a non-limiting example, a compound represented by [Chemical Formula 1] may include a compound represented by [Chemical Formula 2] or [Chemical Formula 3].

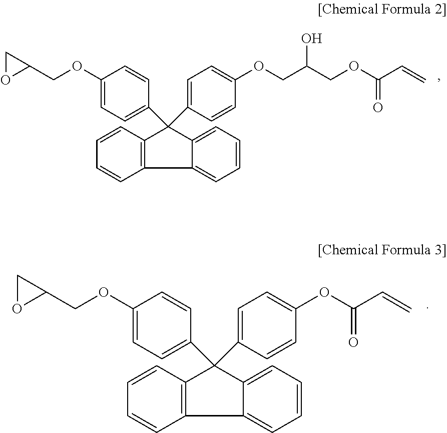 [SMILES: C=CC(=O)OCC(O)COc1ccc(C2(c3ccc(OCC4CO4)cc3)c3ccccc3-c3ccccc32)cc1 ; C=CC(=O)Oc1ccc(C2(c3ccc(OCC4CO4)cc3)c3ccccc3-c3ccccc32)cc1]

A composition according to an embodiment may include a photoinitiator. Any known photoinitiator may be used. The Photoinitiators may be, for example, 2,2-methoxy-1,2-diphenyl ethan-1-one, 1-hydroxy-cyclohexyl phenyl ketone, 2-hydroxy-2-methyl-1-phenyl propan-1-one, 2-methyl-1-[4-(methylthio)phenyl]-2-morpholino propan-1-one, 2-benzyl-2-dimethylamino-1-(4-morpholinophenyl)-butanone-1, bis(2,4,6-trimethylbenzoyl)-phenylphosphine oxide, 2,4,6-trimethylbenzoyl-diphenyl-phosphine oxide, or the like, but the present disclosure is not limited thereto.

Meanwhile, a viscosity of the composition is not particularly limited, but in order to reduce a thickness, the composition according to an embodiment may have a viscosity of 500 cps to 4,000 cps at 25° C.

A structure of the compound represented by [Chemical Formula 1] included in the composition may be confirmed by performing FT-IR analysis, NMR analysis, gas chromatography mass spectrometry (GC-MS), UV-VIS analysis, X-ray photoelectron spectroscopy (XPS), or the like, and may be confirmed by performing, for example, FT-IR analysis and/or NMR analysis.

### Optical Lenses

Hereinafter, an optical lens 100 according to an embodiment of the present disclosure will be described. However, the description duplicating with the description of the composition will be omitted.

The optical lens 100 may include a first lens 110, a second lens 120, and an adhesive layer 130 interposed between the first and second lenses 110 and 120.

The optical lens 100 may have a structure in which a plurality of lenses 110 and 120 having different refractive indices are bonded by the adhesive layer 130, thereby reducing spherical aberration and/or chromatic aberration, suppressing misalignment of an optical axis that may occur during an assembly process, and improving a degree of freedom in lens design.

The adhesive layer 130 may include a repeating unit derived from a compound represented by [Chemical Formula 1]. In the present disclosure, the repeating unit derived from the compound represented by [Chemical Formula 1] may represent a component, structure, or substance itself derived from the compound represented by [Chemical Formula 1], and may refer to a unit formed within a polymer by the compound represented by [Chemical Formula 1] participating in a polymerization reaction. The adhesive layer 130 may provide excellent optical characteristics and adhesive strength by including a repeating unit derived from a compound represented by [Chemical Formula 1].

The repeating unit may be formed through chemical mutual bonding of Y1 and Y2, end groups of a compound represented by [Chemical Formula 1]. For example, the repeating unit may include a bond between an epoxy group of [Chemical Formula 1] and a (meth)acrylate group, a bond between an epoxy group of [Chemical Formula 1] and an epoxy group, and/or a bond between a (meth)acrylate group and a (meth)acrylate group.

X1 and X2 may be the same or different in each repeating unit, X1 and X2 may be a benzene ring in each repeating unit, but the present disclosure is not limited thereto.

R1, R2, R3, R4, a, b, c, and d may be the same or different in each repeating unit. For example, a, b, c, and d may be 0 in each repeating unit. For example, a and b may be 1 in each repeating unit, and c and d may be 0 in each repeating unit.

Meanwhile, the adhesive layer 130 may include a polymer including a repeating unit derived from a compound represented by [Chemical Formula 1], and the polymer may include about 10 to about 1,000 of the repeating units, but the present disclosure is not limited thereto.

The adhesive layer 130 may be formed, for example, by irradiating the composition according to an embodiment of the present disclosure with active energy rays or heating the composition. The adhesive layer 130 may be formed by irradiating the composition with ultraviolet rays, and the irradiation amount of ultraviolet rays may be 3,000 mJ/cm² to 6,000 mJ/cm², but the present disclosure is not limited thereto.

As a non-limiting example, the adhesive layer 130 may include a repeating unit derived from a compound represented by [Chemical Formula 2] or a repeating unit derived from a compound represented by [Chemical Formula 3].

A structure of the repeating unit derived from the compound represented by [Chemical Formula 1] included in the adhesive layer 130 may be confirmed by performing FT-IR analysis, NMR analysis, gas chromatography mass spectrometry (GC-MS), UV-VIS analysis, X-ray photoelectron spectroscopy (XPS), or the like, and may be confirmed by performing, for example, FT-IR analysis and/or NMR analysis. However, the present disclosure is not limited thereto, and the structure of the compound may also be confirmed through other known analysis methods.

The first lens 110 may have, for example, a concave shape on both surfaces in the optical axis direction. A refractive index of the first lens 110 may be greater than a refractive index of the second lens 120. The refractive index of the first lens 110 may be, for example, 1.55 or more and 1.71 or less. The first lens 110 may be a plastic lens, and more specifically, may be a polycarbonate-based plastic lens, but the present disclosure is not limited thereto.

The second lens 120 may have, for example, a convex shape on both surfaces in the optical axis direction. A refractive index of the second lens 120 may be, for example, 1.43 or more and 1.63 or less. The second lens 120 may be a plastic lens, and more specifically, may be a cycloolefin (cyclo-olefin polymer, cyclo-olefin copolymer)-based plastic lens, but the present disclosure is not limited thereto.

The first lens 110 may include a first optical portion 111 refracting light and a first flange portion 112 extending from the first optical portion 111, and the second lens 120 may include a second optical portion 121 refracting light and a second flange portion 122 extending from the second optical portion 121. That is, optical portions 111 and 121 may be a portion exhibiting the optical performance of lenses 110 and 120, and flange portions 112 and 122 may be a portion fixing the lenses 110 and 120 to another configuration. The flange portions 112 and 122 extend from the periphery of the optical portions 111 and 121, and may be integrally formed with the optical portions 111 and 121.

The adhesive layer 130 may have a refractive index between the refractive index of the first lens 110 and the refractive index of the second lens 120 to compensate for the difference in a refractive index between the first lens 110 and the second lens 120. That is, the refractive index of the first lens 110 may be greater than the refractive index of the adhesive layer 130, and the refractive index of the adhesive layer 130 may be greater than the refractive index of the second lens 120. As a result, even when light enters the first lens 110 at an angle equal to or greater than a critical angle, total reflection does not occur at an interface, and the light reaches the second lens 120, thereby increasing light efficiency. That is, light loss that may occur due to difference in refractive index between the first lens 110 and the second lens 120, may be reduced.

The refractive index of the adhesive layer 130 may be, for example, 1.47 or more and 1.67 or less, and 1.50 or more and 1.63 or less, but the present disclosure is not limited thereto. The adhesive layer 130 may be disposed between the first optical portion 111 and the second optical portion 121 and may extend between the first flange portion 112 and the second flange portion 122. When the adhesive layer 130 does not extend between the first flange portion 112 and the second flange portion 122, peeling between the first lens 110 and the second lens 120 may occur due to thermal shock.

In an embodiment, a thickness of the adhesive layer 130 may be 3 microns (μm) or greater. In the range, adhesive performance of the adhesive layer 130 may be sufficiently implemented and the high-temperature reliability of the optical lens 100 may be improved. The upper limit of the thickness of the adhesive layer 130 is not particularly limited, but may be 50 μm or less by considering a physical and chemical characteristics of the adhesive layer 130.

Meanwhile, when a thickness of the adhesive layer 130 in a central region CR disposed between the first optical portion 111 and the second optical portion 121 is ta, and a thickness of the adhesive layer 130 in an external region XR disposed between the first flange portion 112 and the second flange portion 122 is tb, tb>ta may be satisfied. As a result, separation between the first lens 110 and the second lens 120 may be prevented. tb may be, for example, at least twice, and, for another example, at least three times, of ta, but the present disclosure is not limited thereto.

The adhesive layer 130 having a thickness of 3 μm to 50 μm may have a transmittance of 90% or more for light (wavelength 365 nanometers (nm)), but the present disclosure is not limited thereto.

Meanwhile, although two lenses 110 and 120 are illustrated in the drawing, the present disclosure is not limited thereto. For example, the number of lenses included in the optical lens 100 may be changed by those skilled in the art depending on various variables such as purpose of a camera module.

### Lens Assembly

A lens assembly according to an embodiment of the present disclosure may include the optical lens 100 according to an embodiment of the present disclosure. The lens assembly may include a lens barrel having an internal space and the optical lens 100 disposed in the internal space of the lens barrel. A plurality of optical lenses may be disposed in the internal space of the lens barrel, and at least one of the plurality of optical lenses may be the optical lens 100 according to an embodiment of the present disclosure. The lens barrel may be coupled with, for example, the flange portions 112 and 122 of the lenses 110 and 120.

The lens assembly may also have, for example, spacers disposed therein to maintain gaps between the plurality of optical lenses. One or more of the spacers may be provided, and the gaps between the plurality of optical lenses may be determined depends on thicknesses of the spacers. The spacers may have a light-blocking material coated on its surface or a light-blocking film attached thereto to prevent unnecessary light from passing through. The spacers may be formed of an opaque material, or may be manufactured of a non-ferrous metal such as copper or aluminum.

### Camera Module

A camera module according to an embodiment of the present disclosure may include the lens assembly. The camera module may include, for example, a housing accommodating the lens assembly therein. The housing may be coupled with a lens barrel of the lens assembly. The housing and the lens barrel may be coupled, for example, by a screw fastening method or an actuator, but the present disclosure is not limited thereto.

The camera module may include, for example, an image sensor. The image sensor may provide an image-forming surface on its upper surface so that light passing through the lens assembly may be imaged, and may be converted into an electrical signal. The image sensor may be, for example, provided in a rectangular shape, but the present disclosure is not limited thereto. The camera module may include, for example, a printed circuit board. The printed circuit board may be a means for transmitting image signals and may be electrically connected to the image sensor. The image sensor may be mounted on an upper surface of the printed circuit board by a wire bonding method, but the present disclosure is not limited thereto, and the method by which the image sensor and the printed circuit board are electrically connected may be changed in various manners. The image sensor and printed circuit board may be provided, for example, inside the housing.

### Experimental Example 1

An optical lens of [Example 1] was manufactured by applying a composition containing a compound represented by [Chemical Formula 2] and a photoinitiator between the first lens and the second lens, and curing with UV (wavelength: 365 nm, minimum irradiance: 6,000 mJ/cm²) to form an adhesive layer.

In addition, An optical lens of [Comparative Example 1] was manufactured by applying a composition containing a compound represented by [Chemical Formula 4] and a photoinitiator between a first lens and a second lens, and curing with UV (wavelength: 365 nm, minimum irradiance: 3,000 mJ/cm²) to form an adhesive layer.

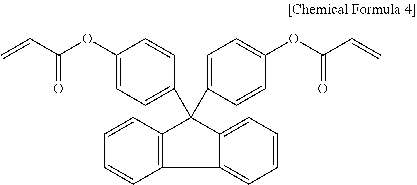 [SMILES: C=CC(=O)Oc1ccc(C2(c3ccc(OC(=O)C=C)cc3)c3ccccc3-c3ccccc32)cc1]

Thereafter, a refractive index and adhesive strength of each of the adhesive layers of [Example 1] and [Comparative Example 1] were measured and recorded in [Table 1] below. The refractive index was measured using a prism coupler (Prism-coupler, Model 2010/M, METRICON). The adhesive strength was measured using a Dage 4000 device.

TABLE 1

| Division | Example 1 | Comparative Example 1 |
|---|---|---|
| Refractive Index (RI) | 1.56 | 1.54 |
| Adhesive Strength (kgf) | 18.8 | 10.9 |

Referring to [Table 1], it may be confirmed that the adhesive layer formed of a composition including a compound represented by [Chemical Formula 2] has an excellent refractive index and adhesive strength compared to the adhesive layer formed of a composition including a compound represented by [Chemical Formula 4].

### Experimental Example 2

A flare evaluation was performed on a lens assembly of [Example 2] and a lens assembly of [Comparative Example 2]. An optical lens of [Example 2] was manufactured using the same method as an optical lens of [Example 1], and the optical lens of [Comparative Example 2] was manufactured using the same method as an optical lens of [Comparative Example 1], but a refractive index of the optical lens of [Comparative Example 2] was 1.5.

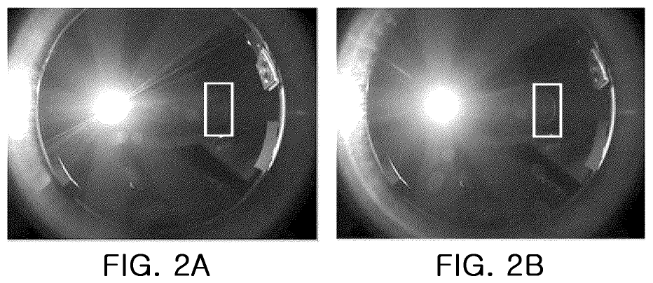

FIG. 2A illustrates an image illustrating a flare phenomenon of [Example 2] and FIG. 2B illustrates a flare phenomenon of [Comparative Example 2]. Referring to FIG. 2A and FIG. 2B, it may be confirmed that [Example 2] has reduced flare compared to [Comparative Example 2]. This is expected to be derived from the fact that the adhesive layer of [Example 2] has a higher refractive index than the adhesive layer of [Comparative Example 2].

### Experimental Example 3

An optical lens of [Example 3-1] was manufactured by applying a composition containing a compound represented by [Chemical Formula 2] and a photoinitiator between a first lens and a second lens and UV curing to form an adhesive layer. A thickness ta in a central region and a thickness tb in an external region of an adhesive layer of [Example 3-1] were 3.5 μm and 9 μm, respectively.

The optical lens of [Example 3-2] was manufactured in the same method as [Example 3-1], but the thickness ta in the central region and the thickness tb in the external region of the adhesive layer were 5 μm and 20 μm, respectively.

The optical lens of [Comparative Example 3] was manufactured in the same method as [Example 3-1], but the thickness ta in the central region of the adhesive layer and the thickness tb in the external region were 6 μm and 0 μm, respectively. That is, the adhesive layer of [Comparative Example 2] exists only between the first optical portion and the second optical portion, and does not extend between the first flange portion and the second flange portion.

After that, the optical lenses of [Example 3-1], [Example 3-2] and [Comparative Example 3] were put in a thermal shock tester, and the optical lenses of [Example 3-1], [Example 3-2], and [Comparative Example 3] were observed after 500 hours.

TABLE 2

| Division | Example 3-1 | Example 3-2 | Comparative Example 3 |
|---|---|---|---|
| ta (μm) | 3.5 | 5 | 6 |
| tb (μm) | 9 | 20 | 0 |

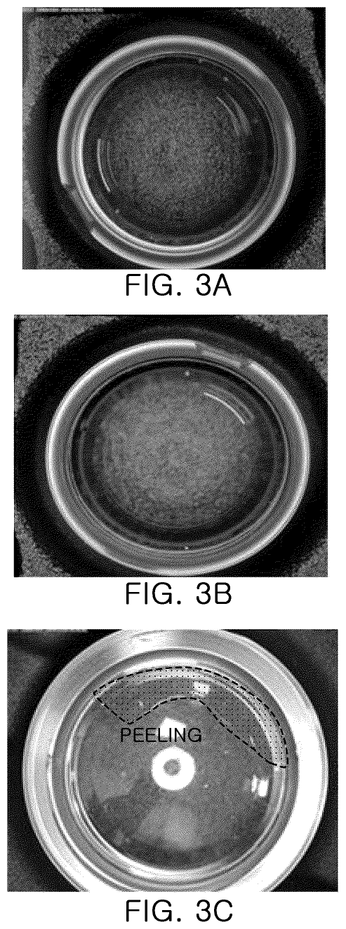

FIG. 3A illustrates an image of filming an appearance of Example 3-1 after completing a thermal shock test for Example 3-1, FIG. 3B illustrates an image of filming an appearance of Example 3-2 after completing a thermal shock test for Example 3-2, and FIG. 3C illustrates an image of an appearance of filming Comparative Example 3 after completing a thermal shock test for Comparative Example 3.

Referring to FIG. 3A to FIG. 3C, it was confirmed that [Examples 3-1] and [Examples 3-2] satisfied tb>ta so that there was no problem with the appearance of the optical lens even after the thermal shock test. However, in the case of [Comparative Example 3], since tb=0, it was confirmed that peeling occurred between the first lens and the second lens. This may be confirmed that the reliability of the optical lens is improved when tb>ta is satisfied.

The present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ may not mean the same embodiment, and may be provided to emphasize and explain different unique characteristics. However, the embodiments presented above do not preclude being implemented in combination with the features of another embodiment. For example, although items described in a specific embodiment may not be described in another embodiment, the items may be understood as a description related to another embodiment unless a description opposite or contradictory to the items is in the other embodiment.

The terms “first,” “second,” and the like may be used to distinguish one element from another, and may not limit a sequence and/or an importance, or others, in relation to the elements. In some cases, a first element may be referred to as a second element, and similarly, a second element may be referred to as a first element without departing from the scope of the example embodiments.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A composition comprising:
a compound represented by the following [Chemical Formula 1]: 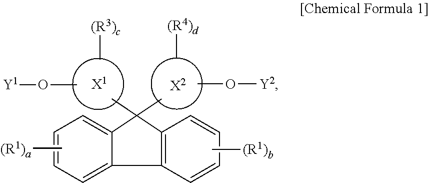
wherein X1 and X2 are each an aromatic ring, R1, R2, R3 and R4 are each a substituent, and a, b, c and d are each an integer from 0 to 4,
where one of Y1 and Y2 comprises a substituted or unsubstituted epoxy group, and the other comprises a substituted or unsubstituted (meth)acrylate group.

2. The composition of claim 1, wherein the X1 and X2 of [Chemical Formula 1] are each a benzene ring.

3. The composition of claim 2, wherein the R1, R2, R3 and R4 of [Chemical Formula 1] are each independently a halogen group, a cyano group, a nitro group, a hydroxy group, a substituted or unsubstituted C1 to C10 alkyl group, a substituted or unsubstituted C1 to C10 alkoxy group, a substituted or unsubstituted C2 to C10 alkene group, a substituted or unsubstituted C2 to C10 alkyne group, or a substituted or unsubstituted phenyl group.

4. The composition of claim 3, wherein the a, b, c and d of [Chemical Formula 1] are each integers of 0.

5. The composition of claim 3, wherein the a and b of [Chemical Formula 1] are each integers of 1,
wherein the c and d of [Chemical Formula 1] are each integers of 0.

6. The composition of claim 1, wherein the compound represented by the [Chemical Formula 1] includes a compound represented by the following [Chemical Formula 2] or [Chemical Formula 3]:

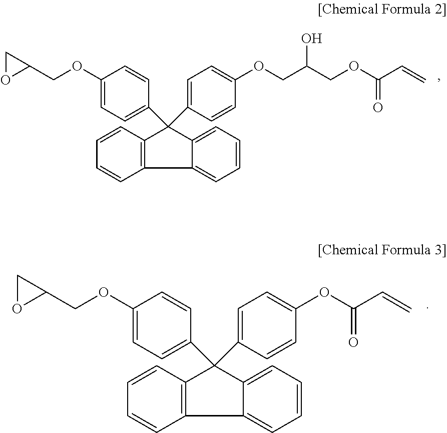 [SMILES: C=CC(=O)OCC(O)COc1ccc(C2(c3ccc(OCC4CO4)cc3)c3ccccc3-c3ccccc32)cc1 ; C=CC(=O)Oc1ccc(C2(c3ccc(OCC4CO4)cc3)c3ccccc3-c3ccccc32)cc1]

7. An optical lens comprising:
first and second lenses; and
an adhesive layer interposed between the first and second lenses,
wherein the adhesive layer includes a repeating unit derived from a compound represented by the following [Chemical Formula 1], 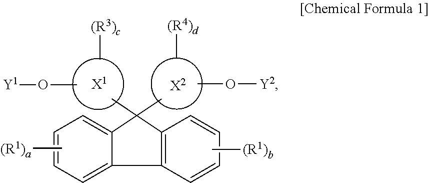
wherein the X1 and X2 are each an aromatic ring, R1, R2, R3 and R4 are each a substituent, and a, b, c and d are each an integer from 0 to 4,
where one of Y1 and Y2 comprises a substituted or unsubstituted epoxy group, and the other comprises a substituted or unsubstituted (meth)acrylate group.

8. The optical lens of claim 7, wherein the X1 and X2 of the [Chemical Formula 1] are each a benzene ring.

9. The optical lens of claim 8, wherein the R1, R2, R3 and R4 of the [Chemical Formula 1] are each independently a halogen group, a cyano group, a nitro group, a hydroxy group, a substituted or unsubstituted C1 to C10 alkyl group, a substituted or unsubstituted C1 to C10 alkoxy group, a substituted or unsubstituted C2 to C10 alkene group, a substituted or unsubstituted C2 to C10 alkyne group, or a substituted or unsubstituted phenyl group.

10. The optical lens of claim 9, wherein the a, b, c and d of [Chemical Formula 1] are each integers of 0.

11. The optical lens of claim 9, wherein the a and b of [Chemical Formula 1] are each integers of 1,
wherein the c and d of [Chemical Formula 1] are each integers of 0.

12. The optical lens of claim 7, wherein the compound represented by the [Chemical Formula 1] includes a compound represented by the following [Chemical Formula 2] or [Chemical Formula 3]:

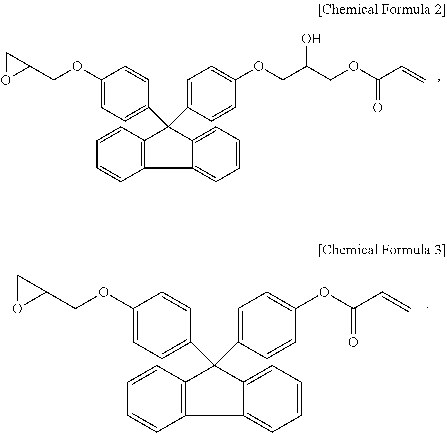 [SMILES: C=CC(=O)OCC(O)COc1ccc(C2(c3ccc(OCC4CO4)cc3)c3ccccc3-c3ccccc32)cc1 ; C=CC(=O)Oc1ccc(C2(c3ccc(OCC4CO4)cc3)c3ccccc3-c3ccccc32)cc1]

13. The optical lens of claim 7, wherein a refractive index of the first lens is greater than a refractive index of the adhesive layer,
wherein the refractive index of the adhesive layer is greater than a refractive index of the second lens.

14. The optical lens of claim 13, wherein the refractive index of the first lens is 1.55 or more and 1.71 or less,
wherein the refractive index of the adhesive layer is 1.47 or more and 1.67 or less,
wherein the refractive index of the second lens is 1.43 or more and 1.63 or less.

15. A lens assembly comprising the optical lens according to claim 7.
